(19) United States
(12) Patent Application Publication
(10) Pub. No.: US 2020/0322130 A1
(43) Pub. Date: Oct. 8, 2020

(54) Decentralized SON and RAN Management Using Blockchain

(71) Applicant: Parallel Wireless, Inc., Nashua, NH (US)

(72) Inventors: Babu Rajagopal, Bangalore (IN); Balaji Jeyabalan, Bangalore (IN)

(21) Appl. No.: 16/841,674

(22) Filed: Apr. 6, 2020

Related U.S. Application Data
(60) Provisional application No. 62/829,141, filed on Apr. 4, 2019.

(51) Int. Cl. H04L 9/06; H04L 29/12; H04W 12/00; G06F 16/23

(52) U.S. Cl. CPC H04L 9/0637; H04L 61/2007; H04W 84/18; H04W 12/0017; G06F 16/2379; H04L 9/0643

(57) ABSTRACT

Systems, methods and computer software are disclosed for decentralizing Self Organizing Network (SON) and Radio Access Network (RAN) management using blockchain. In one embodiment a method is disclosed, comprising: creating, by a HetNet Gateway (HNG), a blockchain genesis block; creating, by the HNG, a datastream; receiving, at the HNG, a configuration request from a Converged Wireless System (CWS); adding, by the HNG, a blockchain block for the CWS; granting permission for the CWS to send and receive data from the blockchain; and sending, by the HNG, a configuration response to the CWS.

### CROSS-REFERENCE TO RELATED APPLICATIONS

This application claims priority under 35 U.S.C. § 119(e) to U.S. Provisional Pat. App. No. 62/829,141, filed Apr. 4, 2019, titled “Decentralized SON and RAN Management Using Blockchain” which is hereby incorporated by reference in its entirety for all purposes. This application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, and U.S. patent application Ser. No. 16/834,573, and U.S. Pat. App. Pub. Nos. US20170273134A1, US20170127409A1 in their entirety.

### BACKGROUND

A blockchain is a growing list of records, called blocks, which are linked using cryptography. Each block contains a cryptographic hash of the previous block, a timestamp, and transaction data. By design, a blockchain is resistant to modification of the data. It is an open, distributed ledger that can record transactions between two parties efficiently and in a verifiable and permanent way. For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority.

Mobile telecommunications networks are networks that provide access for mobile devices to access the global telecommunications network, in particular, the Internet and the telephone network. Currently, the 5G telecommunications network is under active development and standardization by the 3^{rd} Generation Partnership Project (3GPP) organization. The inventors have contemplated the use of the present disclosure for any and all telecommunications networks, including: 2G, GSM, 3G, CDMA, UMTS, 4G, LTE, LTE Advanced, 5G nonstandalone, 5G standalone, license-assisted access (LAA), Wi-Fi, VoIP, and any other telecommunications networks; and for any combination thereof, including a combination in which multiple radio access technologies are provided by a single base station or by a single radio access network. A radio access network (RAN) node is used herein to mean a base station of any type.

Self-organizing networking (SON) is a term generally used within the industry to encompass management functions, e.g., power control, IP address configuration, mobile network operational parameter configuration, etc. being carried out without human intervention or with minimal human intervention.

### SUMMARY

The invention relates generally to using a blockchain for providing decentralized SON and RAN management for network nodes on a mobile network.

In the current architecture, some functionalities like SON, IP allocation are centralized. Using distributed ledger, these can be done without central node. This would be difficult with simple transaction store.

In one embodiment, a method for decentralizing Self Organizing Network (SON) and Radio Access Network (RAN) management using blockchain is described. The method includes creating, by a HetNet Gateway (HNG), a blockchain genesis block; creating, by the HNG, a datastream; receiving, at the HNG, a configuration request from a Converged Wireless System (CWS); adding, by the HNG, a blockchain block for the CWS; granting permission for the CWS to send and receive data from the blockchain; and sending, by the HNG, a configuration response to the CWS.

In another embodiment, a non-transitory computer-readable medium containing instructions for decentralizing Self Organizing Network (SON) and Radio Access Network (RAN) management using blockchain s described. The instructions, when executed, cause a system to perform steps comprising: creating, by a HetNet Gateway (HNG), a blockchain genesis block; creating, by the HNG, a datastream; receiving, at the HNG, a configuration request from a Converged Wireless System (CWS); adding, by the HNG, a blockchain block for the CWS; granting permission for the CWS to send and receive data from the blockchain; and sending, by the HNG, a configuration response to the CWS.

In another embodiment, a system for decentralizing Self Organizing Network (SON) and Radio Access Network (RAN) management using blockchain is disclosed. The system includes a HetNet Gateway (HNG); a Converged Wireless System (CWS) in communication with the HNG; wherein the HNG creates a blockchain genesis block; the HNG creates a datastream; the HNG receives a configuration request from a Converged Wireless System (CWS); the HNG adds a blockchain block for the CWS; the HNG grants permission for the CWS to send and receive data from the blockchain; and the HNG sends a configuration response to the CWS.

Other aspects and advantages of the invention will become apparent from the following drawings, detailed description, and claims, all of which illustrate the principles of the invention, by way of example only.

### BRIEF DESCRIPTION OF THE DRAWINGS

FIG. 1 is a diagram showing aa system showing an HNG and multiple CWSs, in accordance with some embodiments.

FIG. 2 is a diagram showing a signal flow between an HNG, a first CWS and a second CWS, in accordance with some embodiments.

FIG. 3 is a diagram showing an architecture diagram, in accordance with some embodiments.

FIG. 4 is a schematic network architecture diagram for 3G and other-G prior art networks.

FIG. 5 is an enhanced eNodeB for performing the methods described herein, in accordance with some embodiments.

FIG. 6 is a coordinating server for providing services and performing methods as described herein, in accordance with some embodiments.

### DETAILED DESCRIPTION

A blockchain is a content or data structure having a number of serially ordered, back-linked blocks of validated electronic information that may be widely copied to read from or write to. A block is typically a container-type content or data structure that aggregates a list of electronic information and references back to a previous block in the chain (sometimes referred to as a parent block) via a hash of the previous block in the chain. As such, in a blockchain, each block contains a hash of its parent block, linking blocks in the chain via a sequence of hashes all the way to the very first block. Because a current block's hash incorporates a previous block's hash in a blockchain, changing or modifying a parent block would modify a hash of its child's block. In turn, changing or modifying a child block would modify a hash of a grandchild's block and so on. This type of arrangement ensures that a prior block in a chain is extremely difficult to modify due in part, to the compute intensive and time-consuming effort involving re-computations of all previous blocks. Accordingly, prior blocks in a chain become accepted transaction history, and are therefore more secure.

The inventors describe hereinbelow the use of a network architecture in which the main nodes are the CWS and the HNG. The CWS is a multi-RAT base station, which may in certain embodiments include mesh backhaul or in-band/out of band LTE or wireless backhaul. The HNG is a RAN management node situated between one or more RAN nodes and the core network. The core network includes various components which differ based on the network and radio access technology, for example, 3G requiring an SGSN and PDSN, 4G requiring an MME, SGW and PGW. However, the inventors have contemplated the ability for the present disclosure to apply to any core network, so long as a network node is present in the core network to handle blockchain creation and management.

In the current architecture, HNG is the central entity for orchestrating/managing the CWS, SON & S1 Gateway functionality. Management function of CWS that are orchestrated by the HNG include: Initial configuration shall include Radio configuration, IP address allocation, Health check of CWS, Collection of operational data; and for SON Functionality: at least PCI allocation, ANR table, Tx power control. These functions are centralized in HNG mainly because of the need to have a consolidated data to make decisions and notify other nodes. Any, all, none, or any combination of these functions could be provided in conjunction with some embodiments. Only SON functions or only initial configuration functions could be provided in conjunction with some embodiments. Security certificate allocation could be provided in conjunction with some embodiments, including initial configuration embodiments.

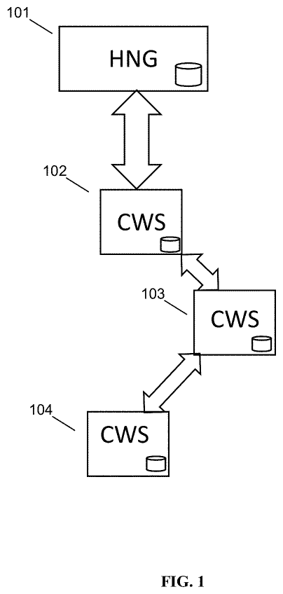

These functions are centralized in HNG mainly because of the need to have a consolidated data to make decisions and notify other nodes. This is shown in FIG. 1 wherein HNG 101 is shown with CWSs 102, 103, 104. Each RAN node 102, 103, 104 has its own data store, which is populated from the data store at the HNG 101.

By enabling private blockchain to distribute data across HNG, CWS, these functions can be decentralized without the need for centralized processing. Advantage of using blockchains include: Scalable Secure & distributed data sharing; Peer-to-peer messaging without the need of central authority.

By using blockchain, a distributed or decentralized configuration management function may be enabled that is able to operate reliably, has offload capability throughout the network, but still retains centralized traceability within the network.

While the present description recites the use of a blockchain, it should be appreciated that where a blockchain is referred to herein, a standard database could also be used in place of a blockchain, in some instances. Blockchain could be mixed with standard transactional databases, in some embodiments, or standard transactional databases could be mixed with authentication and validation data structures and data stores, in some embodiments.

It is understood that where an HNG is referred to in the present disclosure, any relevant node having a data store outside of the RAN (e.g., in one or more core networks) may be substituted. For the example of a node having a configuration data store, in some embodiments, a configuration server could be located in the core network with a configuration data store, and that configuration server could be blockchain-enabled to benefit from the advantages and properties of the present disclosure. As another example, for an initial configuration IP address server for a RAN, a configuration server could be located at or near a cloud edge, or at or near a core network edge, or at or near a RAN edge, in some embodiments, and could be blockchain-enabled.

It is understood that where a CWS is referred to in the present disclosure, any relevant node being a RAN node may be substituted, including RAN nodes capable of one or more of any of the following radio access technologies: 2G; 3G; 4G; 5G; 5G SA; 5G NSA, etc., as well as any combination therein, such as: 2G+4G, 2G+5G, etc., and any RAN node could be blockchain-enabled to interact with a blockchain-enabled data store outside of the RAN, as described throughout the present disclosure and in the previous paragraph.

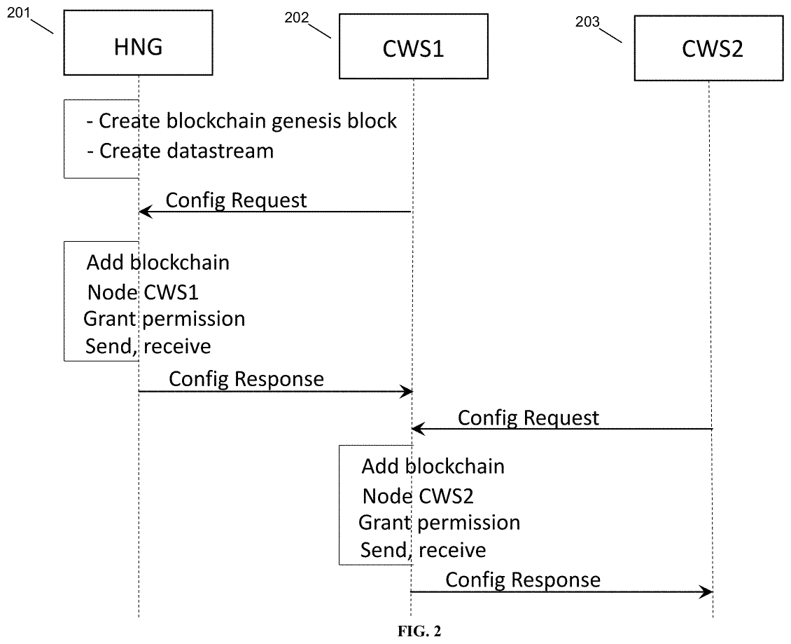

FIG. 2 shows a signal flow between an HNG 201, CWS 1 202, and CWS 2, 203, in accordance with some embodiments.

The idea is to make HNG, CWS part of a private block chain. At node 201, when HNG starts, it will create the initial node containing genesis block in the blockchain. Next, a first CWS 202 will connect to HNG 201 and fetch the configuration information (Radio configuration, IP pool etc.). When this request is made, the CWS 202 will be added to the blockchain network by HNG 201 as another block chain node. This will enable (permission will be granted for) the configuration data to be pushed to CWS from HNG.

Next, we consider an example where CWS is configured in a mesh. As used herein, this mesh use case includes any and all of the following: relay; microwave link; Wi-Fi backhaul link; cellular backhaul, including LTE or 5G backhaul, for a CWS providing LTE or any other cellular radio access technology (RAT) to its users. Mesh does not necessarily include or exclude network topologies where a single node is connected to multiple nodes and is intended to include point-to-point expressions. In some embodiments, CWS-CWS connections are used to fetch configuration information even without a wireless backhaul link, e.g., all nodes are connected via fiber backhaul to the core network; such embodiments are also described by the following description.

In this case the newest node CWS 203 can fetch all the configuration information from the neighboring CWS 202 without contacting HNG. CWS 202, upon receiving a configuration request, may add CWS 203 to the blockchain, and grant permission and send authenticated configuration information to CWS 203. In this way, a blockchain-enabled CWS 202 can help running the following functions in CWS instead of centralized HNG: SON and IP allocation etc., providing decentralized SON, configuration, etc. and a network operator may subsequently validate these steps.

In some embodiments, additional blockchain-related steps may be performed at HNG 201, CWS 202, and CWS 203, including any and all of the steps known to those having skill in the blockchain-related art.

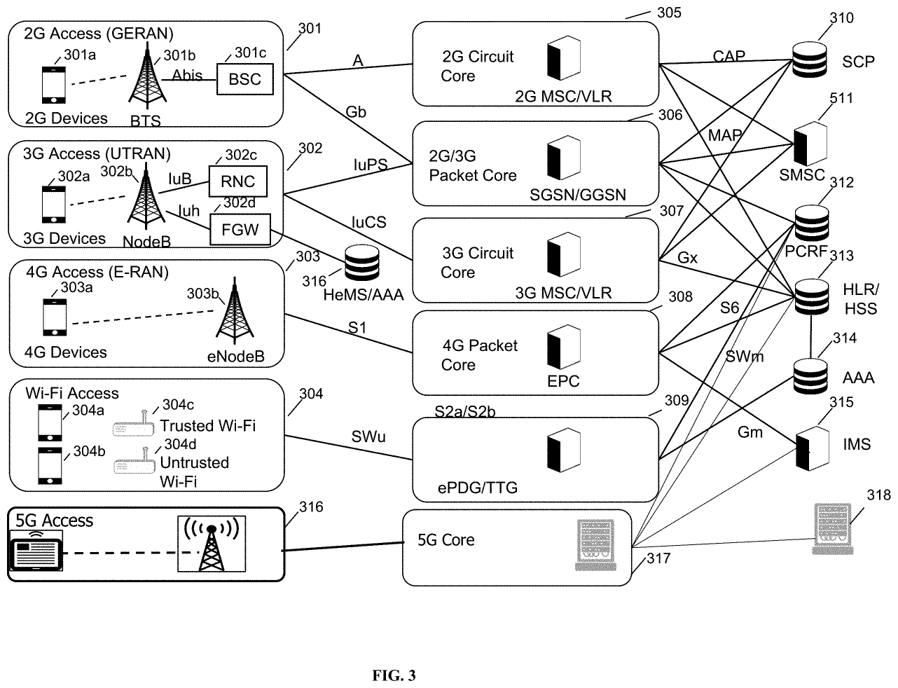

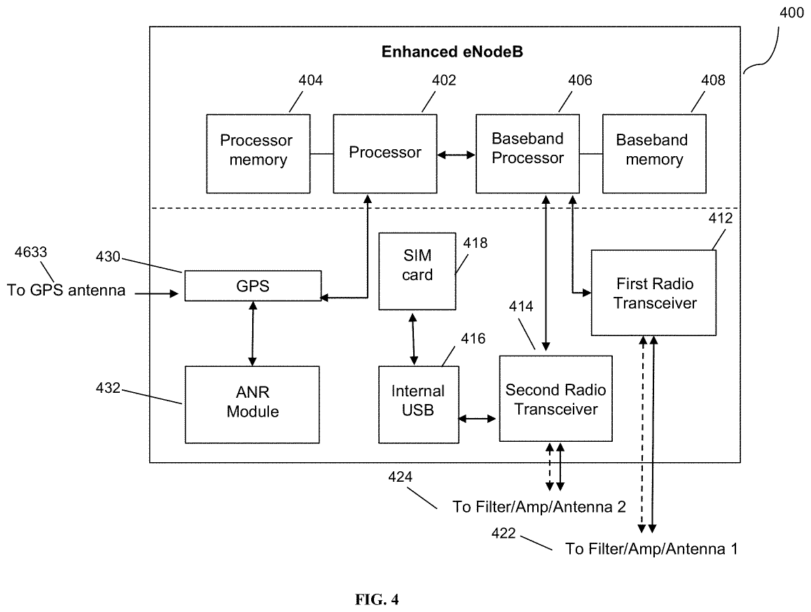

FIG. 3 is a schematic network architecture diagram for 3G and other-G networks, in accordance with some embodiments. The diagram shows a plurality of “Gs,” including 2G, 3G, 4G, 5G and Wi-Fi. 2G is represented by GERAN 301, which includes a 2G device 301a, BTS 301b, and BSC 301c. 3G is represented by UTRAN 302, which includes a 3G UE 302a, nodeB 302b, RNC 302c, and femto gateway (FGW, which in 3GPP namespace is also known as a Home nodeB Gateway or HNBGW) 302d. 4G is represented by EUTRAN or E-RAN 303, which includes an LTE UE 303a and LTE eNodeB 303b. Wi-Fi is represented by Wi-Fi access network 304, which includes a trusted Wi-Fi access point 304c and an untrusted Wi-Fi access point 304d. The Wi-Fi devices 304a and 304b may access either AP 304c or 304d. In the current network architecture, each “G” has a core network. 2G circuit core network 305 includes a 2G MSC/VLR; 2G/3G packet core network 306 includes an SGSN/GGSN (for EDGE or UMTS packet traffic); 3G circuit core 307 includes a 3G MSC/VLR; 4G circuit core 308 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 330, the SMSC 331, PCRF 332, HLR/HSS 333, Authentication, Authorization, and Accounting server (AAA) 334, and IP Multimedia Subsystem (IMS) 335. An HeMS/AAA 336 is present in some cases for use by the 3G UTRAN. The diagram is used to indicate schematically the basic functions of each network as known to one of skill in the art, and is not intended to be exhaustive. For example, 3G core 317 is shown using a single interface to 3G access 316, although in some cases 3G access can be supported using dual connectivity or via a non-standalone deployment architecture.

Noteworthy is that the RANs 301, 302, 303, 304 and 336 rely on specialized core networks 305, 306, 307, 308, 309, 337 but share essential management databases 330, 331, 332, 333, 334, 335, 338. More specifically, for the 2G GERAN, a BSC 301c is required for Abis compatibility with BTS 301b, while for the 3G UTRAN, an RNC 302c is required for Iub compatibility and an FGW 302d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

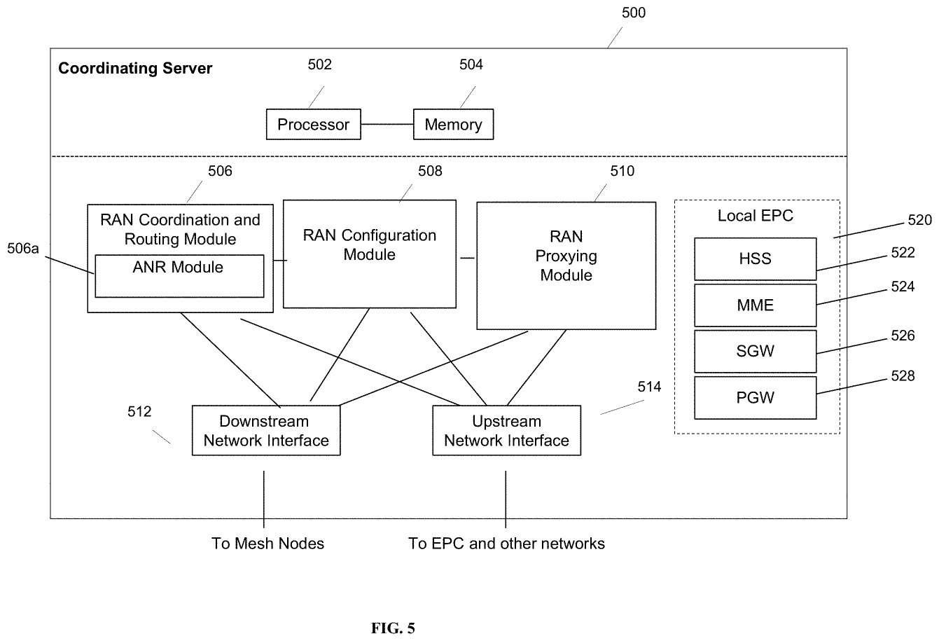

FIG. 5 is an enhanced eNodeB for performing the methods described herein, in accordance with some embodiments. Mesh network node 400 may include processor 402, processor memory 404 in communication with the processor, baseband processor 406, and baseband processor memory 408 in communication with the baseband processor. Mesh network node 400 may also include first radio transceiver 412 and second radio transceiver 414, internal universal serial bus (USB) port 416, and subscriber information module card (SIM card) 418 coupled to USB port 416. In some embodiments, the second radio transceiver 414 itself may be coupled to USB port 416, and communications from the baseband processor may be passed through USB port 416. The second radio transceiver may be used for wirelessly backhauling eNodeB 400.

Processor 402 and baseband processor 406 are in communication with one another. Processor 402 may perform routing functions, and may determine if/when a switch in network configuration is needed. Baseband processor 406 may generate and receive radio signals for both radio transceivers 412 and 414, based on instructions from processor 402. In some embodiments, processors 402 and 406 may be on the same physical logic board. In other embodiments, they may be on separate logic boards.

Processor 402 may identify the appropriate network configuration, and may perform routing of packets from one network interface to another accordingly. Processor 402 may use memory 404, in particular to store a routing table to be used for routing packets. Baseband processor 406 may perform operations to generate the radio frequency signals for transmission or retransmission by both transceivers 410 and 412. Baseband processor 406 may also perform operations to decode signals received by transceivers 412 and 414. Baseband processor 406 may use memory 408 to perform these tasks.

The first radio transceiver 412 may be a radio transceiver capable of providing LTE eNodeB functionality, and may be capable of higher power and multi-channel OFDMA. The second radio transceiver 414 may be a radio transceiver capable of providing LTE UE functionality. Both transceivers 412 and 414 may be capable of receiving and transmitting on one or more LTE bands. In some embodiments, either or both of transceivers 412 and 414 may be capable of providing both LTE eNodeB and LTE UE functionality. Transceiver 412 may be coupled to processor 402 via a Peripheral Component Interconnect-Express (PCI-E) bus, and/or via a daughtercard. As transceiver 414 is for providing LTE UE functionality, in effect emulating a user equipment, it may be connected via the same or different PCI-E bus, or by a USB bus, and may also be coupled to SIM card 418. First transceiver 412 may be coupled to first radio frequency (RF) chain (filter, amplifier, antenna) 422, and second transceiver 414 may be coupled to second RF chain (filter, amplifier, antenna) 424.

SIM card 418 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 400 is not an ordinary UE but instead is a special UE for providing backhaul to device 400.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 412 and 414, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 402 for reconfiguration.

A GPS module 430 may also be included, and may be in communication with a GPS antenna 432 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 432 may also be present and may run on processor 402 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

FIG. 5 is a coordinating server for providing services and performing methods as described herein, in accordance with some embodiments. Coordinating server 500 includes processor 502 and memory 504, which are configured to provide the functions described herein. Also present are radio access network coordination/routing (RAN Coordination and routing) module 506, including ANR module 506a, RAN configuration module 508, and RAN proxying module 510. The ANR module 506a may perform the ANR tracking, PCI disambiguation, ECGI requesting, and GPS coalescing and tracking as described herein, in coordination with RAN coordination module 506 (e.g., for requesting ECGIs, etc.). In some embodiments, coordinating server 500 may coordinate multiple RANs using coordination module 506. In some embodiments, coordination server may also provide proxying, routing virtualization and RAN virtualization, via modules 510 and 508. In some embodiments, a downstream network interface 512 is provided for interfacing with the RANs, which may be a radio interface (e.g., LTE), and an upstream network interface 514 is provided for interfacing with the core network, which may be either a radio interface (e.g., LTE) or a wired interface (e.g., Ethernet).

Coordinator 500 includes local evolved packet core (EPC) module 520, for authenticating users, storing and caching priority profile information, and performing other EPC-dependent functions when no backhaul link is available. Local EPC 520 may include local HSS 522, local MME 524, local SGW 526, and local PGW 528, as well as other modules. Local EPC 520 may incorporate these modules as software modules, processes, or containers. Local EPC 520 may alternatively incorporate these modules as a small number of monolithic software processes. Modules 506, 508, 510 and local EPC 520 may each run on processor 502 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for decentralizing Self Organizing Network (SON) and Radio Access Network (RAN) management using blockchain, comprising:
creating, by a HetNet Gateway (HNG), a blockchain genesis block;
creating, by the HNG, a datastream;
receiving, at the HNG, a configuration request from a Converged Wireless System (CWS);
adding, by the HNG, a blockchain block for the CWS;
granting permission for the CWS to send and receive data from the blockchain; and
sending, by the HNG, a configuration response to the CWS.

2. The method of claim 1 further comprising joining, by the CWS, the blockchain as another blockchain node.

3. The method of claim 2, wherein joining the blockchain as another blockchain node enables configuration data to be pushed to the CWS by the HNG.

4. The method of claim 1 further comprising fetching, by a newest CWS, configuration information from a neighboring CWS without contacting the HNG.

5. The method of claim 1 wherein SON functions are run on the CWS instead of the HNG.

6. The method of claim 1 wherein Internet Protocol (IP) allocation functions are run on the CWS instead of the HNG.

7. A non-transitory computer-readable medium containing instructions for decentralizing Self Organizing Network (SON) and Radio Access Network (RAN) management using blockchain, which, when executed, cause a system to perform steps comprising:
creating, by a HetNet Gateway (HNG), a blockchain genesis block;
creating, by the HNG, a datastream;
receiving, at the HNG, a configuration request from a Converged Wireless System (CWS);
adding, by the HNG, a blockchain block for the CWS;
granting permission for the CWS to send and receive data from the blockchain; and
sending, by the HNG, a configuration response to the CWS.

8. The computer-readable medium of claim 7 further comprising instructions for joining, by the CWS, the blockchain as another blockchain node.

9. The computer-readable medium of claim 8, wherein instructions for joining the blockchain as another blockchain node enables configuration data to be pushed to the CWS by the HNG.

10. The computer-readable medium of claim 8 further comprising instructions for fetching, by a newest CWS, configuration information from a neighboring CWS without contacting the HNG.

11. The computer-readable medium of claim 6 including instructions wherein SON functions are run on the CWS instead of the HNG.

12. The computer-readable medium of claim 7 including instructions wherein Internet Protocol (IP) allocation functions are run on the CWS instead of the HNG.

13. A system for decentralizing Self Organizing Network (SON) and Radio Access Network (RAN) management using blockchain, comprising:
a HetNet Gateway (HNG);
a Converged Wireless System (CWS) in communication with the HNG;
wherein the HNG creates a blockchain genesis block;
the HNG creates a datastream;
the HNG receives a configuration request from a Converged Wireless System (CWS);
the HNG adds a blockchain block for the CWS;
the HNG grants permission for the CWS to send and receive data from the blockchain; and
the HNG sends a configuration response to the CWS.

14. The system of claim 13 wherein the CWS joins the blockchain as another blockchain node.

15. The system of claim 14, wherein joining the blockchain as another blockchain node enables configuration data to be pushed to the CWS by the HNG.

16. The system of claim 13 wherein a new CWS fetches configuration information from a neighboring CWS without contacting the HNG.

17. The system of claim 13 wherein SON functions are run on the CWS instead of the HNG.

18. The system of claim 13 wherein Internet Protocol (IP) allocation functions are run on the CWS instead of the HNG.
